(19) United States
(12) Patent Application Publication
(10) Pub. No.: US 2007/0233435 A1
(43) Pub. Date: Oct. 4, 2007

(54) Boosted linear modeling of non-linear time series

(76) Inventor: Gary Bradski, Palo Alto, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/394,834

(22) Filed: Mar. 31, 2006

(51) Int. Cl. G06F 17/10

(52) U.S. Cl. 703/2

(57) ABSTRACT

A method and apparatus for boosted linear modeling of non-linear time series. An embodiment of a method includes receiving a series of data elements, where the series of data elements is a time series and where the time series has a non-linearity. One or more decision trees are generated for the data elements, with the decision tree models dividing the time series into a plurality of data groups. Further, each of the data groups is modeled as a linear function.

### FIELD

An embodiment of the invention relates to computer analysis of systems in general, and more specifically to boosted linear modeling of non-linear time series.

### BACKGROUND

Data that is received over time is a common phenomenon for analysis. The data may generally be referred to as a time series, which generally refers to any data representing some phenomena over a time period, and which may describe any type of feature or features. Time series analysis is valuable for various purposes, such as tracking and control, prediction of future events or behavior, and smoothing of data, such as in audio or visual data.

Linear time series analysis is well understood, including the common use of auto regressive (AR) models, which fit a line through a certain n points of a time series. Similarly, an auto regressive moving average (ARMA) is intended to fit a line through the last n data points and the last m averages of the data points. An auto regressive integrated moving average (ARIMA) is similar to an ARMA, but also includes predicted outputs of a filter. In each such model, there is commonly an associated order representing of the number of lagged points of each type (past data, past averages, past predictions) that the model attempts to fit. In one possible example, an AR(5) model indicates that the last five points in a time series will be fit to predict the next. Numerous other models are also known.

However, most real phenomena have nonlinearities, which refer to a time series or a portion of a time series that is not linear in nature and thus may not model well as a linear function. The non-linear nature of the data complicates analysis, and makes modeling of phenomena more difficult.

### BRIEF DESCRIPTION OF THE DRAWINGS

The invention may be best understood by referring to the following description and accompanying drawings that are used to illustrate embodiments of the invention. In the drawings:

FIG. 1 is an illustration of the matching of a time series to a line;

FIG. 2 is an illustration of a decision tree that may be used in an embodiment of the invention

FIG. 3 is an illustration of a time series that may be analyzed and modeled in an embodiment of the invention

FIG. 4 shows an embodiment of a decision tree to analyze and model a non-linear time series as multiple linear models

FIG. 5 is an illustration of the linear models chosen to model a non-linear time series in an embodiment of the invention;

FIG. 6 is an illustration of the modeling of a complex non-linear time series in an embodiment of the invention;

FIG. 7 is an illustration of an embodiment of a system for modeling of non-linear time series;

FIG. 8 is a flowchart to illustrate embodiments of a process for generating linear models of non-linear data using Person's r coefficient;

FIG. 9 is a flowchart to illustrate an embodiment of a process for boosting linear models of non-linear data; and

FIG. 10 is an illustration of a computer system that may be used in an embodiment of the invention.

### DETAILED DESCRIPTION

A method and apparatus are described for boosted linear modeling of non-linear time series.

As used herein, “time series” means a series or sequence of data values over time. For example, a series of data values representing a particular system represents a time series. The data values may be multi-dimensional, representing various different features of a phenomenon. A time series may be analyzed and modeled to gain insight into a system, to predict outcomes, to control operations, or for other purposes.

As used herein, “decision tree” means an analysis instrument for which outcomes to certain conditions or features are represented by branches, which may branch further by additional conditions or features. At minimum, a decision tree may represent one condition resulting in two possible result nodes, which may be referred to as a “stump”. As used herein, a decision tree may include the separation of data in a time series. A decision tree is a flow chart or diagram representing a classification system or predictive model. In machine learning, a decision tree is a predictive model; that is, a mapping of observations about an item to conclusions about the item's target value or class. The tree is structured as a sequence of simple questions with the answers tracing a path down the tree.

As used herein, “auto regressive model” means a model that uses past values of data to predict future values of the data. Mathematically, an auto regressive model represents data as an auto regressive process, which is a process in which the current value of a time series is related to a certain number of past values. If a process is related to the past n values, n being any integer, the process is an AR(n) process.

As used herein, “boosting” means a process sequentially adding classifiers to an ensemble of classifiers each of which successively try to minimize the error output from the previous members of the ensemble. In the process, a misclassification weight (or “weighted misclassification cost”) placed on each data point is changed to reflect how many times the classifiers were correct or incorrect in predicting that point. Here, boosting includes increasing the weight placed on incorrectly predicted data for an autoregressive or similar model and decreasing the weight for correctly predicted data.

As used herein, “purity” or “homogeneity” means the degree to which data in a particular group is of the same type. For instance, in a decision tree, the level of purity is the degree to which data for a particular node is in the same class or regression level. This may be measured, for example, by the degree to which data points in any given leaf node are within a set distance of the mean value of that leaf. If leaf nodes of a decision tree are required to have 100% purity, then all data points for any leaf node would fit this category. However, any level of purity may be used for decision trees.

In one embodiment of the invention, a system provides for modeling of a non-linear time series by use of boosted linear time series models. In an embodiment of the invention, a time series is analyzed using a decision tree to identify segments of a non-linear time series that may be modeled as linear time series. In an embodiment of the invention, models may be further boosted to increase the accuracy of the resulting linear time series models.

In an embodiment of the invention, a time series analyzer includes a decision tree module that divides a non-linear time series into multiple data groups. The time series analyzer further includes a modeling module that models each such portion of the time series as a linear model, or classifier. The time series analyzer further includes a boosting module that provides a boosting of weak classifiers to produce a stronger prediction model. In an embodiment of the invention, models revert to standard linear time series models if a linear fit works well for a time series.

Time series modeling has a wide variety of usages, from control, to prediction of sensor data, to monitoring and analysis of events that occur over time. In an embodiment of the invention, the models may be implemented for machine learning in which computers map data for predictive models. The purposes of analysis of data further may include data mining, which is the process of exploration and analysis, by automatic means, of large quantities of data in order to discover meaningful patterns and rules. Because of the value of time series analysis in a wide variety of enterprises, efficient and accurate modeling of time series is extremely useful. Numerous modeling processes are available for linear time series modeling, and such models have the advantage of simplicity and ease of calculation. However, many time series are non-linear in nature, which thus may involve more complex modeling. In an embodiment of the invention, linear time series models are extended to non-linear time series by embedding these linear time series models into a piecewise linear decision tree. In an embodiment of the invention, statistical boosting, which combines weaker models together into a stronger model, is also used to combine multiple linear trees to improve time series fitting results. Boosted decision trees have the advantage of tending to produce more accurate predictions, and providing greater stability against sampling variability in data points.

In a simplest form, linear modeling of a time series may be represented by fitting a line through all of some portion of the time series data to represent the data trend. Simple linear time series models include the AR (auto regressive model—fitting a line through a certain n points of a time series), ARMA (auto regressive moving average—fitting a line through the last n data points and the last m averages of the data points), ARIMA (auto regressive integrated moving average—operating in the same manner as ARMA, but also including predicted outputs in the fitting of the line), and others. While embodiments of the invention may be applied to any such model, the examples provided here focus on AR models for simplicity. It will be apparent to a person skilled in the art that the techniques described here also apply to other linear modeling processes.

To fit an AR model to a time series, there is a determination of the order of the function, which reflects the number of points to be considered. For example, if the previous p points yₜ₋₁, yₜ₋₂, . . . , Yₜ₋ₚ are to considered and β represents the coefficients for the model, then the output yₜ may be predicted by:

$${y}_{t} = {β}_{0} + {\sum }_{j = 1}^{p} {y}_{t - j} {β}_{j} \qquad ( 1 )$$

In this example, it is possible to include the constant axis intercept term β₀ into y and β and then rewrite the equation in vector form as:
y=X^{T}β (2)
where X=1, Yₜ₋₁, yₜ₋₂, . . . , yₜ₋ₚ. Using the vector form of the equation, the least squares solution (representing a statistical solution that minimizes the sum of the squares of the residuals between observations and the model) then may be expressed as:
β=(X^{T}X)⁻¹X^{T}y (3)

The foregoing represents the simplest method of fitting the coefficients β of an AR model. In the modeling of data, many different models are possible, with differing qualities as to how well the model fits the actual data in a time series. To measure how well a modeled line fits the data, which might not be entirely linear or may include noise, various known techniques may be used to make the determination. Such methods include the sum of squared distances from the line, Pearson's coefficient “r” (where r is bound between −1 <opposite>, and 1 <best>) which measures how correlated the linearity is between 2 data sequences (one of which is a line in the present case), and r² (which is bound between 0, representing no fit and 1, representing a perfect fit). Those skilled in the art will be aware of various methods for measuring the fit of data to a line.

Decision trees and ensembles of trees may be formed using certain known techniques, which include decision tree based methods such as Classification and Regression Trees (CART), as well as tools such as multivariate adaptive regression splines (MARS), TreeNet MART, and the algorithm ID3 introduced by J. Ross Quinlan and related extension C4.5. In CART analysis, data is divided into exactly two subgroups (or “nodes”). The split for each node is based on questions (which may be referred to as conditions or features) that have a “yes” or “no” answer. The conditions are chosen using an exhaustive, recursive partitioning routine to examine possible binary splits in the data. In determining the conditions that will be used in the process, there is comparison of all the possible splits and the split with the highest degree of homogeneity or purity is selected. The process is continued for resulting nodes and, as the tree evolves, the nodes become increasingly more homogenous, identifying segments or classes. This process may be repeated until sufficient levels of homogeneity are reached. The resulting decision tree model may then be pruned by comparing learning and test data. The resulting model is called a decision tree. CART has numerous advantages, including that the resulting decision trees are easy to interpret, that the process may occur automatically, and that the computations may be done quickly by computer.

A summary of a CART decision tree algorithm may be as follows:

(1) Search through the features of the data to find a single feature and a threshold value that best “purifies” or splits the data into two sets where each set contains data that are most like each other, that are most homogenous. This best feature with its corresponding split threshold is referred to herein as a “node”.

(2) Continue process (1) with the resulting nodes. Features may possibly be reused in other splits. The process continues until the data is parsed into leaf nodes that attain a certain level of purity. For example, if the set level of purity is 100%, then each leaf node would be required to be completely pure, with only one value or class for each final split. However, any predetermined level of purity may be used.

(3) Prune the tree back up until a complexity measure is satisfied. Thus, if a tree leaf results from n branches, and thus there are n splits, this may be cut back to a smaller number m if necessary.

In an embodiment of the invention, a decision tree is used to evaluate a non-linear time series. In an example, a time series consists of data points that are ordered in time. The data points may be high dimensional (having multiple values), and may represented as y_{t-q}, . . . , yₜ₋ₚ, . . . , yₜ. The series of data point is input into a decision tree that uses a sliding window of p points, which breaks up the time series into overlapping chunks of p points each:
(yₜ₋ₚ₋ₙ, . . . , yₜ₋ₙ); (yₜ₋ₚ₋ₙ₊₁, . . . , yₜ₋ₙ₊₁); . . . ; (y₋ₚ, . . . , yₜ) (4)
For the purposes to the analysis, each one of the windows or chunks of data is considered to be a “data point” consisting each of p lagged features or variables.

In an embodiment of the invention, a decision tree model is modified as follows by taking notice that a criteria is to fit a linear model to subsets of data. The modeling may utilize AR or other linear models. The fit may be measured by any suitable measure of fit to a line. In an embodiment, a leaf node's r² score discussed above being within a set distance of 1.0. In an embodiment of the invention, process for generation of a decision tree for a time series includes:

(1) Searching through the features for the time series data, which in this case are lagged data points that include the previous p points in time, to find the single feature and its value that separates the data into 2 sets that maximizes the total r² over both sets.

(2) Continue process (1), with possibly reusing certain features, until the data is parsed into tree leaves each within, for example, a required threshold r² score of 1.0. In one example, if the threshold is 0.2, then all r² in any given leaf fit must be at 0.8 or higher.

(3) Prune the decision tree back up until a certain complexity measure is satisfied.

In an embodiment of the invention, the decision tree will break up a non-linear input into separate linear models. In an embodiment, if a time series models well as a line, then the decision tree will have no splits and thus the model will default to a standard linear model, such as an AR, ARMA or ARIMA model. Thus, decision tree time series models presented in an embodiment of the invention are a superset of linear models.

In an embodiment of the invention, the modeling of non-linear data is improved by boosting of the models. Statistical boosting works by learning a “weak” classifier, such as a decision tree with only one split. The data set is tested through the learned model to determine where the model makes errors. More weight is then placed on the data points that were wrongly predicted. The re-weighted data is then used to learn and test a new weak classifier. This process is continued until a certain number M of simple classifiers are learned, all with weights proportional to how the errors are formed. When the models are then run on future data, a new data point is passed to all M decision trees and the weighted results, or “votes”, are used to form a final answer.

There are many statistical boosting techniques, such as gentle boost, float boost, gradient boost and AdaBoost, that are well known by those in the machine learning, statistics, and related arts. To provide a specific example here, AdaBoost is described, but other boosting techniques could be used by a similar modification at the leaves of the tree. AdaBoost is an algorithm for constructing a strong classifier as a linear combination of weak classifiers. The boosting process can achieve substantially better prediction or regression results over the weak classifiers, as well also being applicable for strong classifiers. In an embodiment of the invention, trees of linear regression models may be boosted a time series model process. For example, a set of time series includes N data points of p data elements, as described by the windows of data (yₜ₋ₚ₋ₙ, . . . , yₜ₋ₙ); (yₜ₋ₚ₋ₙ₊₁, . . . , yₜ₋ₙ₊₁); . . . ; (yₜ₋ₚ, . . . , yₜ), which may be referred to as ^{p}yᵢ, i=1, . . . , N This data will be used in learning and testing the models, and thus may be referred to as the “training data”. In an embodiment of the invention, a boosted time series model process may be implemented as:

(1) Determine the structure of decision trees to be used. In one embodiment, a depth of an AR decision tree is chosen. In one embodiment, only “stumps” are used, each providing one split only.

(2) Initialize a set of weights wᵢ=1/N, i=1,2, . . . , N for the training data, the weights representing the weighted misclassification costs. Equal weights are generally initially used for the data elements.

(3) Learn a weak classifier stump or limited decision tree on the training data. Assuming that there will be M decision tree classifiers, for m=1 to M follow the following processes:
(a) Fit one of the classifiers Gₘ(^{p}y) to the training data using the current weighted misclassification costs wᵢ.
(b) Compute an error value:

$${err}_{m} = \frac{{\sum }_{i = 1}^{N} {w}_{i} I ( {r}^{2} < t )}{{\sum }_{i = 1}^{N} {w}_{i}} \qquad ( 5 )$$

where I( . . . ) is an indicator function that is equal to 1 if true, and is equal to 0 otherwise.
(c) Compute a weight adjustment factor αₘ=log((1−errₘ)/errₘ) for use in adjusting the weighted misclassifiation cost of the training data values to reflect the data points that were not predicted correctly.
(d) Reset the weight values to reflect the additional weight to be placed on the incorrectly predicted items, each weight factor is adjusted as follows:
   wᵢ←wᵢ·exp[αₘ·(r²<t)], i=1,2, . . . , N (6)
(e) Repeat the process (3) for the next classifier, this time using the adjusted weights for the data.

(4) Output the resulting boosted classifiers for use for the data series:

$${G}_{m} ( {}_{}^{p}{y}{}_{j}^{} ) = \frac{{\sum }_{m = 1}^{M} {α}_{m} {G}_{m} ( {}_{}^{p}{y}{}_{j}^{} )}{{\sum }_{m = 1}^{M} {α}_{m}} \qquad ( 7 )$$

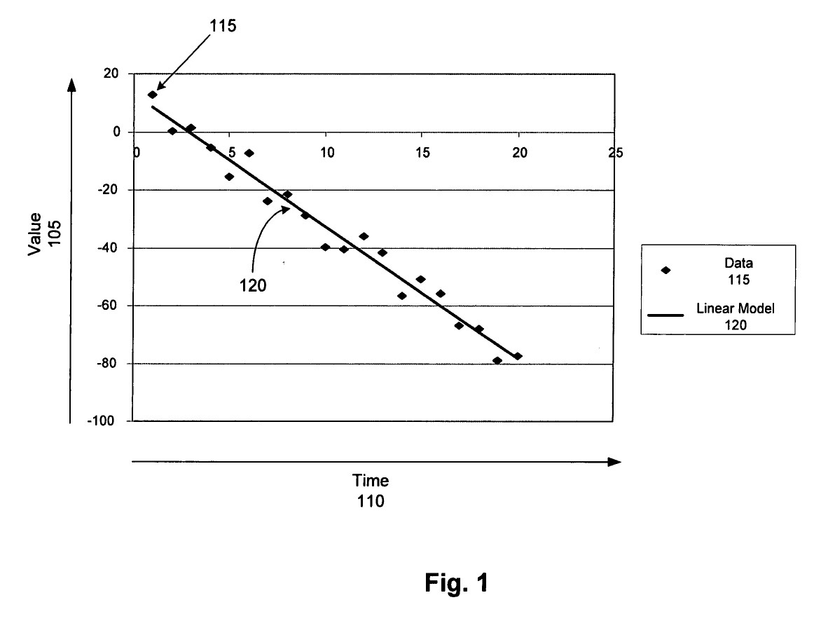

FIG. 1 is an illustration of the matching of a time series to a line. In an embodiment of the invention, a certain time series including a series of data elements 115 is graphed according to a certain value 105 against time 110. As this is essentially a linear phenomenon, standard linear modeling tools can be used to fit the data to a linear model 120. In an embodiment of the invention, the linear modeling tools that can be used for linear data are expanded for use in non-linear time series, and are boosted to provide a more accurate and stable result.

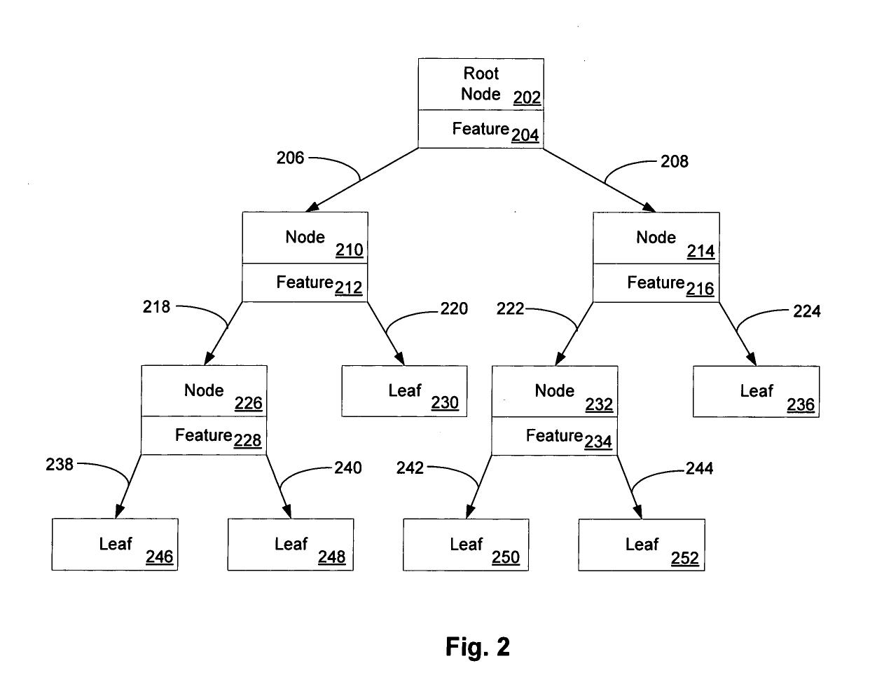

FIG. 2 is an illustration of a decision tree that may be used in an embodiment of the invention. In this illustration there is a root node 202. A feature 204 is chosen with the intent of dividing the data into two groups, with each group having a high degree of purity. In this example, branches 206 and 208 result in nodes 210 and 214. At this point, if the purity does not meet a certain threshold, the process continues, with features 212 and 216 being chosen, which follow to branches 218 and 220 for feature 212 and branches 222 and 224 for feature 216. In this case branch 220 results in a leaf node 230 that meets the required standard of purity, as does leaf node 236 from branch 224. The other branches require more processing, with branch 218 leading to node 226, for which feature 228 is chosen, resulting in leaf node 246 from branch 238 and leaf node 248 from branch 240. In addition, branch 222 leads to node 232, for which feature 234 is chosen, resulting in leaf node 250 from branch 242 and leaf node 252 from branch 244.

At this point, the branches may be pruned back if the result is beyond a certain complexity threshold established for the process. For example, leaf nodes 246, 248, 250, and 252 may be pruned back to reduce the complexity of the decision tree.

In an embodiment of the invention, decision trees are used to separate portions of a non-linear time series. In this embodiment, the features chosen separate a time series into portions that can be modeled using linear models. In an embodiment of the invention, the modeling is improved through boosting of the decision models.

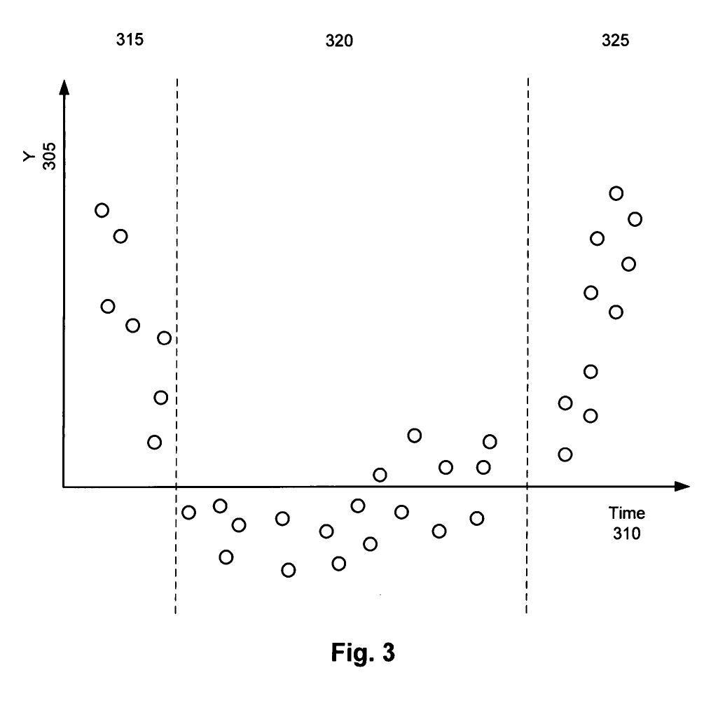

FIG. 3 is an illustration of a time series that may be analyzed and modeled in an embodiment of the invention. In this illustration, the data series is graphed as a value Y 305 against time 310. In an embodiment of the invention, the time series may be divided into portions that may be modeled as linear models. In this example, the time series may be divided into a first region 315, a second region 320, and a third region 325. In an embodiment, a decision tree includes a first feature that divides one of the regions from the remaining regions, thereby establishing a first leaf node. Further, another feature divides the remaining two regions, thereby establishing a second leaf node and a third leaf node. The data elements represented by each of the two leaf nodes may then be modeled using linear modeling techniques.

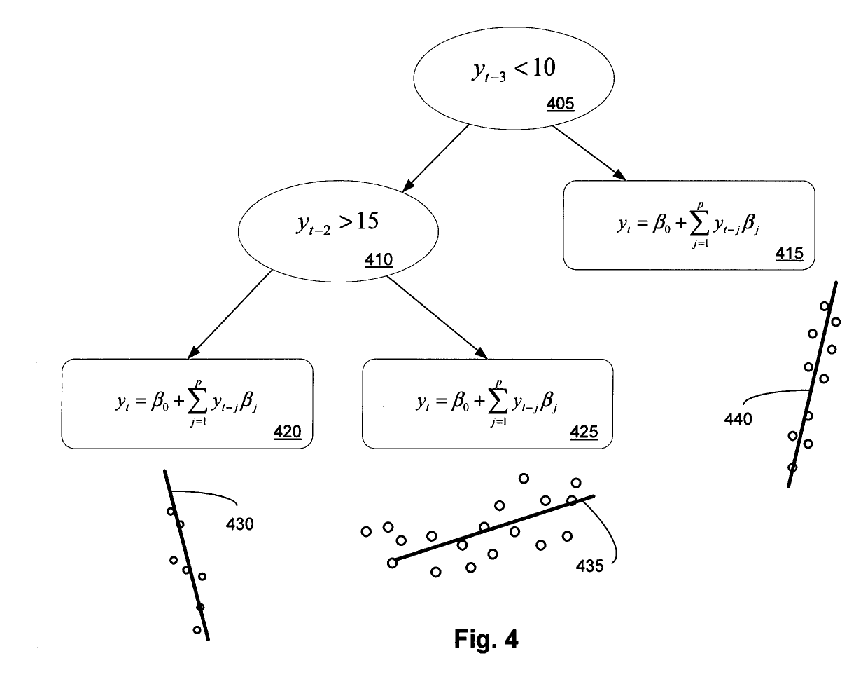

FIG. 4 shows an embodiment of a decision tree to analyze and model a non-linear time series as multiple linear models. In FIG. 4, the data series shown in FIG. 3 is subject to analysis. It is assumed that there is a window that includes a certain number of past time periods. For example, the points may be represented as y_{t-q}, . . . , yₜ₋ₚ, . . . , yₜ. In this example, the series of data point is input into a decision tree that includes a sliding window of p points, which breaks up the time series into overlapping chunks of p points each: (yₜ₋ₚ₋ₙ, . . . , yₜ₋ₙ); (yₜ₋ₚ₋ₙ₊₁, . . . , yₜ₋ₙ₊₁); . . . ; (yₜ₋ₚ, . . . , yₜ). Each of the windows or chunks of data are considered data “points” consisting each of p lagged features or variables.

For the decision tree shown in FIG. 4, a first feature is chosen that, in this case, will separate the rightmost region, region 325 in FIG. 3, from the rest. In this example, a feature has been chosen that will provide the highest level of purity in the resulting leaf node. For example, the feature may be yₜ₋₃<10 450, which determines for any window whether the point yₜ₋₃, the point three time periods to the left in the window, is less than a certain value. In this case, such point will be reached when the rightmost region 325 of FIG. 3 is reached, and the resulting data points may be modeled as a line 415, with the resulting line being line 440. In this example, the remaining data points do not reach the required level of purity, and thus another feature is chosen. The feature yₜ₋₂>15 may be chosen, for example, which will determine whether the point yₜ₋₂, the point two time periods to the left in the window, is less that a certain value. In this case, such point will be reached when the middle region 320 of FIG. 3 is reached, and the resulting data points in each of the two regions may be modeled as 420 and 425. In this example, the remaining data points do achieve the required level of purity, and thus no more features are chosen. The data points from region 315 of FIG. 3 are modeled as line 430, and the data points from the middle region 320 of FIG. 3 are modeled as line 435.

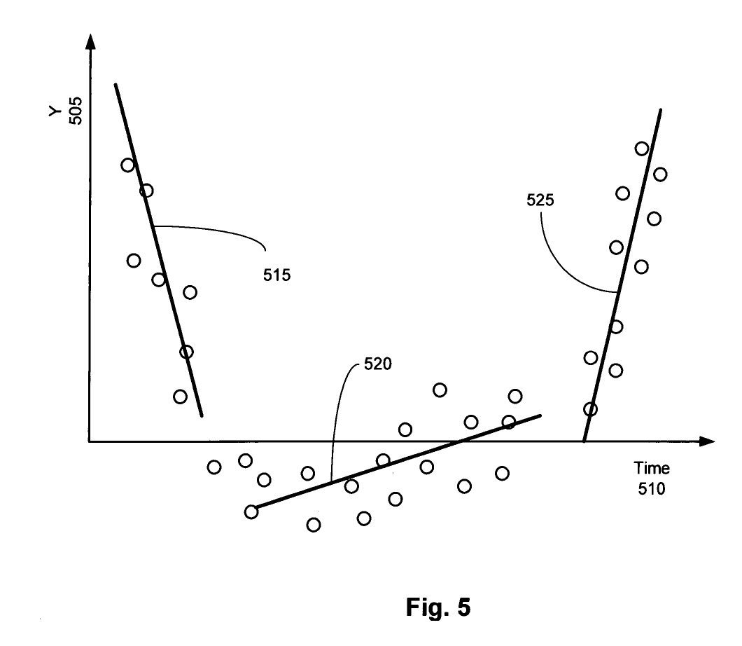

FIG. 5 is an illustration of the linear models chosen to model a non-linear time series in an embodiment of the invention. In this illustration, the time series is again graphed as a value Y 505 against time 510. In this illustration, the illustrated non-linear time series is modeled as a first linear model 515, a second linear model 520, and a third linear model 525.

In an embodiment of the invention, the resulting models may be statistically boosted to increase the accuracy and stability of the resulting models.

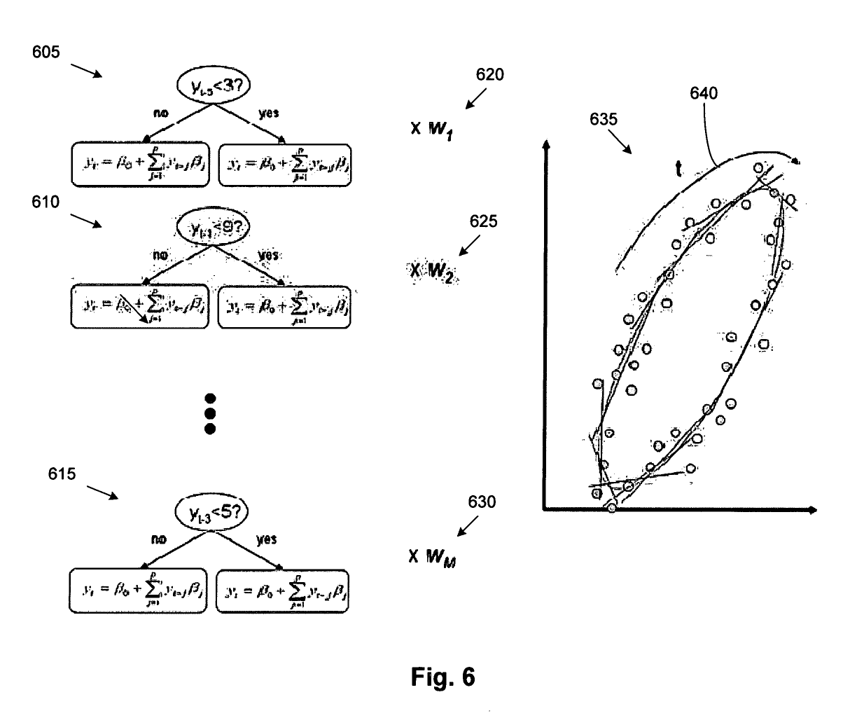

FIG. 6 is an illustration of the modeling of a complex non-linear time series in an embodiment of the invention. In this illustration, a time series 635 creates an elliptical loop 640 over time. In this illustration, the classifier is comprised of multiple “stumps” that divide the time series into two leaf nodes, such as features yₜ₋₅<3 605, yₜ₋₁<9 610, and continuing through an mth feature yₜ₋₃<5 615.

In this illustration, the models are boosted to increase the accuracy and stability of the modeling. In this way, boosting techniques are extended to time series fitting for more stable, accurate fitting results. For example, weight adjustment factors α are learned for each of the decision tree stumps depending on its weighted prediction performance. The cost for mispredicting each training data point by the next decision tree 605 is encoded as a set of weight values w₁ 620 (representing weighted misclassification costs), which may be initialized as equal weight values. The weight values may then be adjusted based on the predictive results, such that incorrectly predicted points are given more weight. The training data for decision tree 610 then may be multiplied times an adjusted set of weight values w₂ 626, and continuing through the training data for 615 being multiplied times an adjusted weight W_{M} 630.

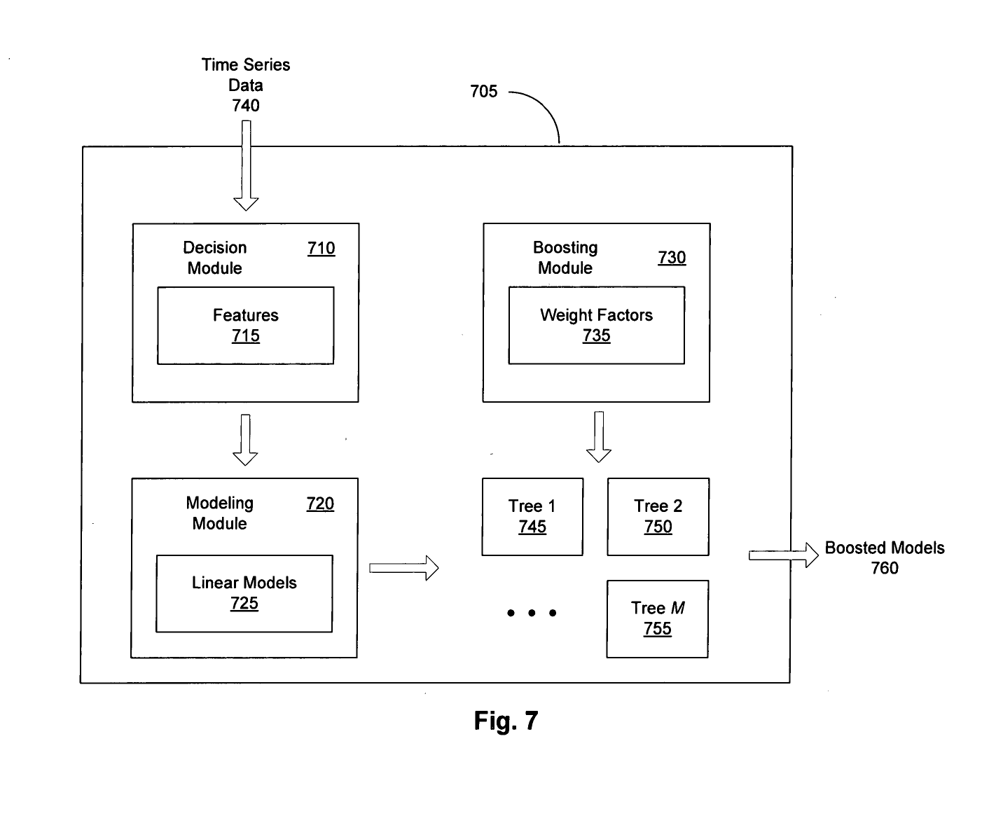

FIG. 7 is an illustration of an embodiment of a system for modeling of non-linear time series. In this illustration, a time series analyzer 705 includes a decision module 710 for generation of decision trees, a modeling module 720 for generation of linear models, and a boosting module 730 for boosting of the linear models to produce more accurate and stable results. For example, a set of time series data 740 is received as an input to the time series analyzer 705. The time series data 740 may represent any kind of phenomenon, and which may include a non-linear data set that would not model well as a single linear solution. The time series data 740 is processed by the decision module 710, which chooses features 715 for the data 725 that will separate the data into sections that will attain a sufficient level of purity. The resulting decision tree 735 is processed by the modeling module, which models the data according to certain linear models 740, resulting in decisions trees, show as tree 1 745, tree 2 750, and continuing through tree M 755. These decisions tree models 745-755 then learned one by one using statistical boosting by the boosting module 730, each one receiving a weight adjustment factor α for its later vote on testing data. During this process the data weighted miscalculation factors w 735 are adjusted to put more weight on data points that are not predicted correctly.

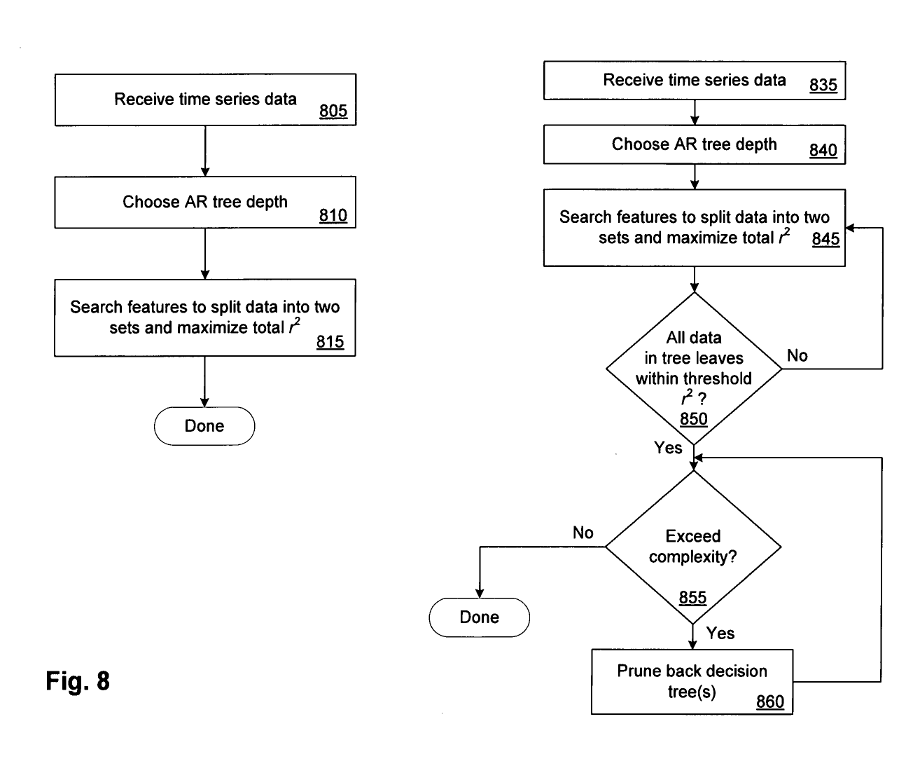

FIG. 8 is a flowchart to illustrate embodiments of a process for generating linear models of non-linear data using Person's r coefficient. In a first embodiment, time series data is received 805, with the data representing a non-linear phenomenon. The original time series data is in the form of a sequence of windowed data points each of a pre-chosen length extracted from sliding a window of length p over the original data. These datapoints may each carry a weighted misclassification cost “w”. Each windowed data point “j” then contains p features each with weighted misclassification cost wⱼ. In an embodiment of the invention, a particular auto regressive tree depth may be chosen 810. In an example, a number of trees with only one split (stumps) may be used. The features of the time series data are searched to find a feature that splits the data into two sets and maximize the total r² value for the data sets 815.

In a second embodiment that may include pruning of decision trees, time series data is again received in windowed, cost weighted form 835, with the data representing a non-linear phenomenon. A complexity threshold may be chosen 840, and the features of the time series data are searched to find a feature that will splits the data into two sets and maximize the total r² value for the data sets 845. In this embodiment, there is a weighted determination whether all data in the resulting nodes is of the requisite purity 850. If not, then there is a search for features for additional splits 845. If so, there is a determination whether the resulting tree exceeds a complexity measure 860, which in this case would be the chosen AR tree depth. If so, then the decision tree or trees are pruned back 860, and the complexity may again be determined 855. If not, the resulting decision tree is output for boosting.

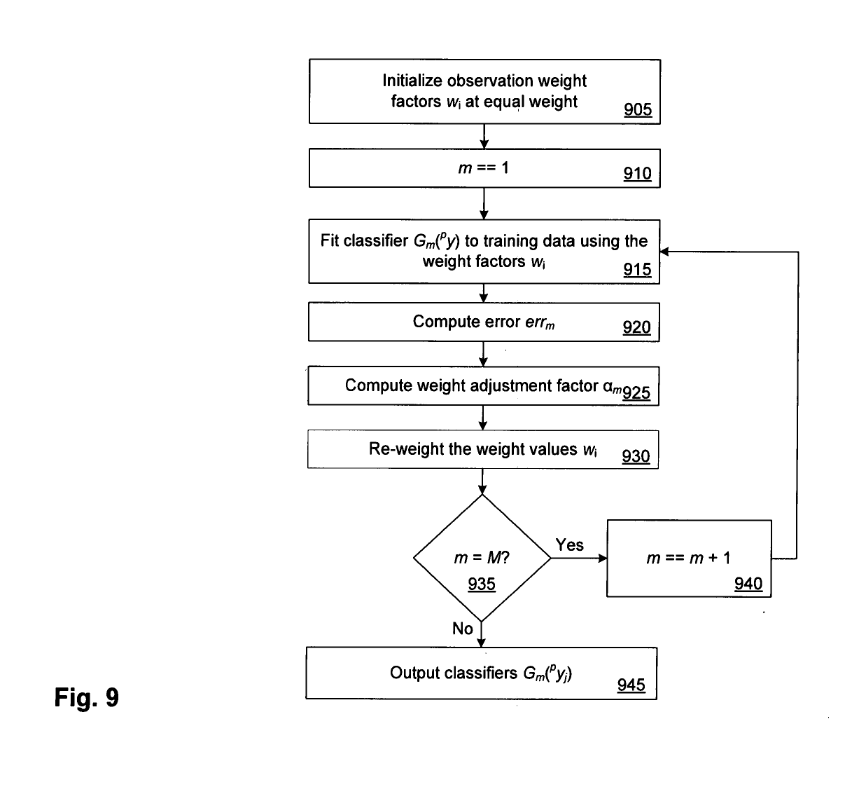

FIG. 9 is a flowchart to illustrate an embodiment of a process for boosting linear models of non-linear data. In this embodiment, decision tree or trees will be generated, such as under the processes illustrated in FIG. 8. A set of weighted miscalculation values wᵢ are initialized at an equal weight for each data point 905. In this embodiment, it is assumed that there will be M decision trees learned, where M may be any integer of one or more. Each such decision tree may be a weak classifier. For purposes of illustrating the process, a counter m is initialized at 1 and the first classifier is applied to a set of training data using the current weight factor wᵢ 915. An error value errₘ is computed based on data points that are incorrectly predicted using the current classifier. A weight adjustment factor αₘ is computed for that weak classifier based on the incorrect predictions 925, and the weight values w are reallocated to place more weight on the incorrectly predicted data points 930. If there additional decision trees to process, and thus m has not reached M 935, then m is incremented 940 and the next classifier is fit to the training data 915. The process continues with each succeeding decision tree, whose weight adjustment factor α can provide a strong ensemble classifier for non-linear time series from the relatively weak component classifiers. When all classifiers and their weights have been calculated, then the classifiers are output 945.

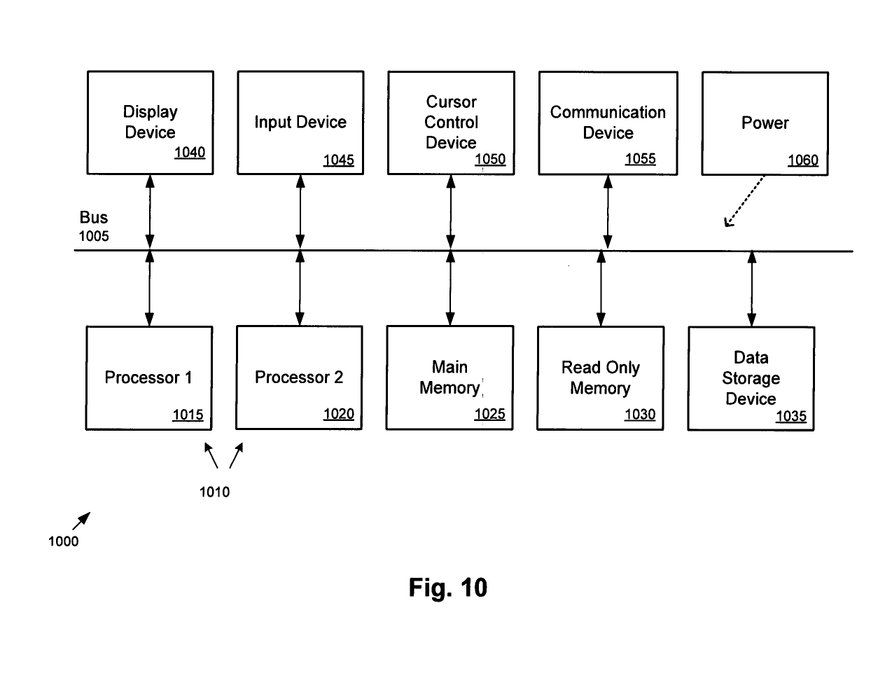

FIG. 10 is an illustration of a computer system that may be used in an embodiment of the invention. Certain standard and well-known components that are not germane to the present invention are not shown. Under an embodiment of the invention, a computer 1000 comprises a bus 1005 or other communication means for communicating information, and a processing means such as two or more processors 1010 (shown as a first processor 1015 and a second processor 1020) coupled with the bus 1005 for processing information. The processors 1010 may comprise one or more physical processors and one or more logical processors. Further, each of the processors 1010 may include multiple processor cores. The computer 1000 is illustrated with a single bus 1005 for simplicity, but the computer may have multiple different buses and the component connections to such buses may vary. The bus 1005 shown in FIG. 10 is an abstraction that represents any one or more separate physical buses, point-to-point connections, or both connected by appropriate bridges, adapters, or controllers. The bus 1005, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire”. (“Standard for a High Performance Serial Bus” 1394-1995, IEEE, published Aug. 30, 1996, and supplements) In an embodiment of the invention, the processors 1010 may be used to analyze and model a non-linear time series.

The computer 1000 further comprises a random access memory (RAM) or other dynamic storage device as a main memory 1025 for storing information and instructions to be executed by the processors 1010. Main memory 1025 also may be used for storing temporary variables or other intermediate information during execution of instructions by the processors 1010. The uses of the main memory include the storage of a received time series for analysis. The computer 1000 also may comprise a read only memory (ROM) 1030 and/or other static storage device for storing static information and instructions for the processors 1010.

A data storage device 1035 may also be coupled to the bus 1005 of the computer 1000 for storing information and instructions. The data storage device 1035 may include a magnetic disk or optical disc and its corresponding drive, flash memory or other nonvolatile memory, or other memory device. Such elements may be combined together or may be separate components, and utilize parts of other elements of the computer 1000.

The computer 1000 may also be coupled via the bus 1005 to a display device 1040, such as a cathode ray tube (CRT) display, a liquid crystal display (LCD), a plasma display, or any other display technology, for displaying information to an end user. In some environments, the display device may be a touch-screen that is also utilized as at least a part of an input device. In some environments, display device 1040 may be or may include an audio device, such as a speaker for providing audio information. An input device 1045 may be coupled to the bus 1005 for communicating information and/or command selections to the processors 1010. In various implementations, input device 1045 may be a keyboard, a keypad, a touch-screen and stylus, a voice-activated system, or other input device, or combinations of such devices. Another type of user input device that may be included is a cursor control device 1050, such as a mouse, a trackball, or cursor direction keys for communicating direction information and command selections to the one or more processors 1010 and for controlling cursor movement on the display device 1040.

A communication device 1055 may also be coupled to the bus 1005. Depending upon the particular implementation, the communication device 1055 may include a transceiver, a wireless modem, a network interface card, LAN (Local Area Network) on motherboard, or other interface device. In one embodiment, the communication device 1055 may include a firewall to protect the computer 1000 from improper access. The computer 1000 may be linked to a network or to other devices using the communication device 1055, which may include links to the Internet, a local area network, or another environment. The computer 1000 may also comprise a power device or system 1060, which may comprise a power supply, a battery, a solar cell, a fuel cell, or other system or device for providing or generating power. The power provided by the power device or system 1060 may be distributed as required to elements of the computer 1000.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A computer implemented method comprising:
receiving a series of data elements, the series of data elements comprising a time series, the time series having a non-linearity;
generating one or more decision trees for the data elements, the one or more decision tree models dividing the time series into a plurality of data groups; and
modeling each of the data groups as a linear function.

2. The method of claim 1, further comprising statistically boosting the one or more decision tree models.

3. The method of claim 2, wherein boosting the one or more decision tree models comprises providing a set of training data to a first decision tree model and determining which data points are incorrectly predicted.

4. The method of claim 3, wherein boosting the one or more decision tree models further comprises generating a weight adjustment factor for the decision tree.

5. The method of claim 4, wherein boosting the one or more decision tree models further comprises using the weight adjustment factor to adjust a weight value allocated to each data element of the training data based on which data points are incorrectly predicted.

6. The method of claim 1, wherein generating the one or more decision tree models includes performing an autoregressive analysis of the time series over a previous n data points.

7. The method of claim 1, wherein generating the one or more decision tree models further includes choosing a feature of the time series data and separating the time series data based on whether each data point meets a requirement of the feature.

8. A time series analyzer comprising:
a first module to divide a non-linear time series into a plurality of data groups;
a second module to model each of the plurality of portions as a linear time series model; and
a third module to statistically boost the plurality of linear time series models.

9. The time series analyzer of claim 8, wherein the division of the time series into a plurality of data groups includes choosing a data feature to maximize homogeneity between data groups.

10. The time series analyzer of claim 9, wherein the first module divides the time series using one or more decision trees.

11. The time series analyzer of claim 10, wherein the one or more decision trees are based on Classification and Regression Trees (CART) technology.

12. The time series analyzer of claim 10, wherein each of the one or more decision trees comprises a stump with a single split.

13. A system comprising:
a communication device to receive time series data for analysis, the time series data being non-linear;
a dynamic access memory to hold the time series data received by the communication device; and
a processor to perform time series analysis, the processor to split the time series data into a plurality of data sets, the processor to model each of the data sets as a linear model.

14. The system of claim 13, wherein the processor is to further statistically boost the linear models.

15. The system of claim 14, wherein the processor boosting the linear models includes modifying a weight value for each data point being processed using the linear model, wherein the modification of the weight values increases the weight given to a data point that is predicted incorrectly and generates a weighted vote for the associated linear model.

16. The system of claim 13, wherein the processor is to split the time series data using one or more decision trees.

17. A machine-readable medium having stored thereon data representing sequences of instructions that, when executed by a machine, cause the machine to perform operations comprising:
receiving data in a time series, the time series being non-linear;
generating a plurality of decision tree models for the data elements, the plurality of decision tree models dividing the time series into a plurality of data groups according to data features, the plurality of decision tree models modeling each of the data groups as a linear function; and
statistically boosting the plurality of decision tree models.

18. The medium of claim 17, wherein boosting the plurality of decision tree models comprises applying a set of training data to a first decision tree model of the plurality of decision tree models and determining which data points of the set of training data are incorrectly predicted by the first decision tree model.

19. The medium of claim 17, wherein boosting the plurality of decision tree models further comprises adjusting the weight given to each data element of the training data based on which data points are determined to be incorrectly predicted.

20. The medium of claim 19, wherein boosting the plurality of decision tree models further comprises applying the training data with adjusted weights to a second decision tree model of the plurality of decision tree models and further generating a weighted vote for the first decision tree model.

21. The medium of claim 17, wherein generating the one or more decision tree models further includes choosing a feature of the time series data for each of the one or more decision tree models and separating the time series data based on whether each data point meets a requirement of the feature.

22. The medium of claim 21, wherein a first feature is used for a first decision tree model of the plurality of decision tree models and for a second decision tree model of the plurality of decision tree models.
